(19) United States
(12) Patent Application Publication
(10) Pub. No.: US 2008/0160862 A1
(43) Pub. Date: Jul. 3, 2008

(54) Polyolefin Composition, Fibres and Nonwoven Fabrics

(75) Inventors: Franco Sartori, Ferrara (IT); Gabriella Sartori, Ferrara (IT)

Correspondence Address: Basell USA Inc., Delaware Corporate Center II, 2 Righter Parkway, Suite #300, Wilmington, DE, 19803, US

(73) Assignee: Basell Poliolefine Italia s.r.l., Milan (IT)

(21) Appl. No.: 11/792,803

(22) PCT Filed: Nov. 7, 2005
(86) PCT No.: PCT/EP2005/055789

§ 371 Date: Jun. 11, 2007

Related U.S. Application Data
(60) Provisional application No. 60/657,624, filed on Mar. 2, 2005.

(30) Foreign Application Priority Data
Dec. 13, 2004 (EP) 04029445.6

(51) Int. Cl. D04H 3/16; C08L 23/10

(52) U.S. Cl. 442/401; 525/240; 264/115

(57) ABSTRACT

A polyolefin composition comprising (parts by weight) (A) 100 parts of a crystalline isotactic propylene polymer resin having a molecular weight distribution ( M̅_{w}/ M̅ₙ) less than 3, the proportion of inversely inserted propylene units based on 2,1 insertions of a propylene monomer in all propylene insertions, i.e. 2,1 insertions, is as low as 0.5% or less, and a value of the melt flow rate (MFR) from 20 to 60 g/10 min; and (B) 0.1-1 part of a high molecular weight propylene polymer (B) having a value of melt strength from 5 to 40 cN.

Fibres prepared from the said composition exhibit a good balance between elasticity and tenacity.

This application is the U.S. national phase of International Application PCT/EP2005/055789, filed Nov. 7, 2005, claiming priority to European Patent Application 04029445.6 filed Dec. 13, 2004, and the benefit under 35 U.S.C. 119(e) of U.S. Provisional Application No. 60/657,624, filed Mar. 2, 2005; the disclosures of International Application PCT/EP2005/055789, European Patent Application 04029445.6 and U.S. Provisional Application No. 60/657,624, each as filed, are incorporated herein by reference.

The present invention relates to polyolefin fibres, articles produced from said fibres and a polyolefin composition for the preparation of the said fibres. In particular, the invention concerns a polyolefin composition capable of bestowing a good balance between mechanical properties, more particularly between tenacity and elongation at break, on the fibres produced from it. More specifically, the invention relates to a composition made from a homogenous propylene polymer blended with a high melt strength propylene polymer material.

The definition for fibres includes spunbonding fibres and/or filaments.

The polyolefin fibres of the present invention are particularly adequate for high tenacity, soft non-woven fabrics and high tenacity continuous filament applications, such as ropes, handles, belts and strips for back-packs and handbags.

It is known in the prior art that a high melt strength propylene polymer material can be blended with a propylene polymer resin and the composition thus obtained is used to produce fibres.

For example, European patent application 625545 discloses a propylene polymer composition comprising (a) propylene polymer resin and (b) a normally solid, high molecular weight, gel-free propylene polymer material, which is the said high melt strength propylene polymer material. The type of catalyst used in the process for the preparation of the polymer resin as well as structural features of the resin except for the MFR values is not defined in the application. Small amounts of propylene polymer material (b) are added to resin so that the dye receptivity of the resin is improved. The said composition is therefore suitable to prepare coloured fibres. The fibres exhibit substantially the same mechanical properties of the fibres prepared with the resin alone in spite of the presence of material (b).

European patent application 743380 discloses staple fibres and continuous filaments obtained by spinning a composition made up of (a) a propylene polymer resin blended with (b) a high melt strength propylene polymer material and then drawing the solid fibres thus obtained with specific draw ratios. Staple fibres with higher tenacity are obtained without reducing the productivity. The said known fibres exhibit higher tenacity, but only a slight improvement in the elastic property, in particular elongation at break. In addition, the spinnability of the polyolefin composition containing the high melt strength polymer remarkably worsens.

Now it has surprisingly been found that by incorporating small amounts of a high melt strength propylene polymer material into a homogenous propylene polymer resin, a polyolefin composition is obtained which can be transformed into fibres having higher values of elongation at break and still good tenacity in comparison with the fibres produced with the resin alone.

A great advantage in the use of the above-mentioned propylene polymer composition in the production of fibres is that the fibres thus obtained are more flexible. The said feature leads to a more homogenous distribution of the fibres in non-woven fabrics prepared from them. Consequently, the thus-obtained non-woven fabrics have a better, homogeneous appearance.

Another advantage of the present invention is that softness of the fibres and, consequently, non-woven fabrics thereof is also increased. Users will particularly appreciate that certain articles, in particular disposable articles, exhibit the said property.

An additional advantage of the composition according to the present invention is that no remarkable worsening effect on spinning speed occurs; the spinning speed of the composition is about the same as that of the resin alone.

The fibres possess the above-mentioned balance of mechanical properties because the fibres are prepared with an olefin propylene polymer composition containing a polyolefin with a very narrow molecular weight distribution and a high melt strength propylene polymer.

Therefore, an embodiment of the present invention is a polyolefin composition comprising (parts by weight):
A) 100 parts of a crystalline propylene polymer resin (A) having the following features:
   1) a molecular weight distribution expressed by the ratio between the weight average molecular weight and numeric average molecular weight, i.e. M̅_{w}/ M̅ₙ, measured by GPC, less than 3, preferably less than 2.5;
   2) the proportion of inversely inserted propylene units based on 2,1 insertions of a propylene monomer in all propylene insertions, i.e. 2,1 insertions, is as low as 0.5% or less, and
   3) a value of the melt flow rate (MFR) from 20 to 500, preferably 20-60 g/10 min; and
B) 0.1-1, preferably 0.15-0.6, more preferably over 0.2 to 0.6, part of a high molecular weight propylene polymer (B) having a value of melt strength from 5 to 40 cN.

Another embodiment according to the present invention is therefore a fibre made from the said polyolefin composition.

The fibres according to the present invention typically exhibit an increase of elongation at break of at least 100% with respect the value of elongation at break of polymer (A) alone. The said fibres can exhibit a decrease of tenacity. However, the said decrease is less than 20%, preferably 15% with respect to the value of the tenacity of polymer (A) alone.

The above polymer resin (A) preferably has a value of melt flow rate from 25 to 60 g/10 min. As is known, high MFR values are obtained directly in polymerization or by controlled radical degradation of the polymer by adding free-radical generators, such as organic peroxides, in the spinning lines or during previous pelletizing stages of the olefin polymers.

Polymer resin (A) exhibits a stereoregularity of the isotactic type. It is either a propylene homopolymer or a random polymer of propylene with an α-olefin selected from ethylene and a linear or branched C₄-C₈ α-olefin, such as copolymers and terpolymers of propylene. Polymer resin (A) can also be mixtures of the said polymers, in which case the mixing ratios are not critical. Preferably, the α-olefin is selected from the class consisting of ethylene, 1-butene, 1-pentene, 1-hexene, 1-heptene, 1-octene, 1-nonene, 1-decene and 4-methyl-1-pentene. The preferred amount of commoner content ranges up to 15% by weight.

Typically in polymer resin (A) the proportion of inversely inserted propylene units based on 2,1 insertions of a propylene monomer in all propylene insertions, i.e. the content of regioerrors, is over 0.05%, more typically over 0.1%. Polymer (A) contains regioerrors because in the polymerization, the 1,2-insertion (methylene side is bonded to the catalyst) of the propylene monomer mainly takes place, but the 2,1-insertion sometimes takes place. Therefore, the propylene polymer contains the inversely inserted units based on the 2,1-insertion. The proportion of the inversely inserted units based on the 2,1-insertion are calculated from a specific formula by using ¹³C-NMR. European patent application 629632 shows a formula to calculate the proportion of the inversely inserted units based on the 2,1-insertion.

Polymer (B) is semi-crystalline and has a stereoregularity of isotactic type of the propylenic sequences.

Polymer (B) is a normally solid, high molecular weight, gel-free propylene polymer material. It is normally characterised by (1) a branching index of less than 1 and significant strain hardening elongational viscosity or (2) at least (a) either z-average molecular weight M̅z of at least 1.0×10⁶ or a ratio of the z-average molecular weight ( M̅z) to weight average molecular weight ( M̅w), M̅z/ M̅w, of at least 3.0 and (b) either equilibrium compliance (Jₑₒ) of at least 12×10⁵ cm²/dyne or recoverable shear strain per unit stress (Sr/S) of at least 5×10⁵ cm²/dyne at 1 sec⁻¹.

By high molecular weight is meant a polymer with a weight average molecular weight of at least about 50,000, preferably about 100,000.

As used herein “z-average molecular weight”, “equilibrium compliance” and recoverable shear strain per unit stress are defined in U.S. Pat. No. 5,116,881.

Polymer (B) is a propylene polymer having a branching index preferably from 0.1 to 0.9, more preferably from 0.25 to 0.8. The branching index, which is a measure of the degree of branching of the polymer long chain, is defined by the following formula:

(I.V.)₁/(I.V.)₂

where (I.V.)₁ represents the intrinsic viscosity of the branched polymer and (I.V.)₂ represents the intrinsic viscosity of the linear polymer having substantially the same weight average molecular weight. The intrinsic viscosities are determined in tetrahydronaphthaline at 135° C.

The said propylene polymer (B) is selected from:

a) a propylene homopolymer;
b) a random copolymer of propylene and an olefin selected from ethylene and C₄-C₁₀ α-olefins, provided that when said olefin is ethylene, the maximum content of polymerized ethylene is about 5% by weight, preferably about 4%, and when said olefin is a C₄-C₁₀ α-olefins the maximum of polymerized α-olefin is about 20% by weight, preferably about 16%; and
c) the random copolymer of propylene with two olefins selected from ethylene and C₄-C₈ α-olefins, provided that when said olefin is a C₄-C₈ α-olefins the maximum content of polymerized α-olefin is about 20% by weight, preferably about 16%, and that when said olefin is ethylene, the maximum content of polymerized ethylene is about 5% by weight, preferably about 4%.

Preferably propylene polymer (B) is a propylene homopolymer.

The above mentioned α-olefins in propylene polymer (B) can be linear or branched, and are preferably selected from 1-butene, 1-isobutene, 1-pentene, 3-methyl-1-butene, 1-hexene, 3,4-dimethyl-1-butene, 1-heptene, and 3-methyl-1-hexene.

Propylene polymer (B) can be prepared using various techniques starting with the corresponding conventional linear polymers. In particular it is possible to subject the linear polymers to controlled modification processes by way of radical generators through irradiation or peroxide treatment. The starting polymers are linear, have high molecular weight, are normally solid, and can be in any form, such as, spheroidal, fine powder, granules, flake and pellets.

The irradiation method is typically carried out according to what is described in U.S. Pat. Nos. 4,916,198 and 5,047,445, where the polymers are treated with high power radiations (such as electrons or gamma radiations for example). By way of example the quantity of radiation ranges from 0.25 and 20 MRad, preferably 3-12 Rad, and the irradiation intensity ranges from 1 to 10,000 MRad per minute, preferably from 18 to 2,000 MRad per minute.

The treatment with peroxides is carried out, for example, according to the method described in U.S. Pat. No. 5,047,485. It provides for the mixing of the linear polymers with organic peroxides and subsequent heating of the mixture to a temperature sufficient to decompose the peroxides.

Polymer resin (A) can be produced by polymerizing propylene and, optionally, an α-olefin mentioned above in the presence of an opportune catalyst, such as a metallocene catalyst. For the purpose of the present invention with the term metallocene it is intended a transition metal compound containing at least one π bond.

The metallocene-based catalyst system is preferably obtainable by contacting:

a) at least a transition metal compound containing at least one π bond;
b) at least an alumoxane or a compound able to form an alkylmetallocene cation; and
c) optionally an organo aluminum compound.

The metallocene-based catalyst can be suitably supported on an inert carrier. This is achieved by depositing the transition metal compound a) or the product of the reaction thereof with the component b), or the component b) and then the transition metal compound a) on an inert support such as, for example, silica, alumina, Al—Si, Al—Mg mixed oxides, porous magnesium halides, such as those described in WO 95/32995, styrene/divinylbenzene copolymers or porous polyolefins, such as polyethylene or polypropylene. Another suitable class of supports comprises porous organic supports functionalized with groups having active hydrogen atoms. Particularly suitable are those in which the organic support is a partially cross-linked styrene polymer. Supports of this type are described in EP 633 272.

Preferred classes of metallocene compounds are those belonging to the following formulas (I), (II) or (III):

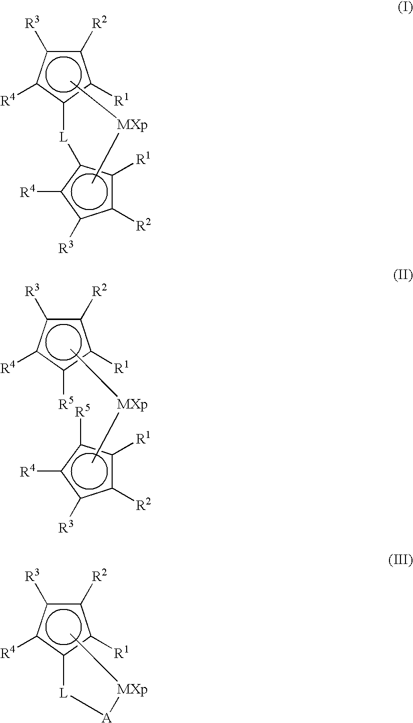

wherein M is a transition metal belonging to group 4, 5 or to the lanthanide or actinide groups of the Periodic Table of the Elements; preferably M is zirconium, titanium or hafnium;
the substituents X, equal to or different from each other, are monoanionic sigma ligands selected from the group consisting of hydrogen, halogen, R⁶, OR⁶, OCOR⁶, SR⁶, NR⁶₂ and PR⁶₂, wherein R⁶ is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl group, optionally containing one or more Si or Ge atoms; the substituents X are preferably the same and are preferably R⁶, OR⁶ and NR⁶₂; wherein R⁶ is preferably a C₁-C₇ alkyl, C₆-C₁₄ aryl or C₇-C₁₄ arylalkyl group, optionally containing one or more Si or Ge atoms; more preferably, the substituents X are selected from the group consisting of —Cl, —Br, -Me, -Et, -n-Bu, -sec-Bu, -Ph, -Bz, —CH₂SiNe₃, —OEt, —OPr, —OBu, —OBz and —NMe₂;
p is an integer equal to the oxidation state of the metal M minus 2;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms such as SiMe₂, SiPh₂; preferably L is a divalent group (ZR⁷ₘ)ₙ; Z being C, Si, Ge, N or P, and the R⁷ groups, equal to or different from each other, being hydrogen or linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl groups or two R¹ can form a aliphatic or aromatic C₄-C₇ ring;
m is 1 or 2, and more specifically it is 1 when Z is N or P, and it is 2 when Z is C, Si or Ge; n is an integer ranging from 1 to 4; preferably n is 1 or 2;
more preferably L is selected from Si(CH₃)₂, SiPh₂, SiPhMe, SiMe(SiMe₃), CH₂, (CH₂)₂, (CH₂)₃ or C(CH₃)₂;
A is a NR⁸, O, S radical, wherein R⁸ is a C₁-C₂₀ hydrocarbon group optionally containing one or more heteroatoms belonging to groups 13-17 of the Periodic Table of the Elements; preferably R⁸ is a linear or branched, cyclic or acyclic, C₁-C₂₀-alkyl, C₂-C₂₀ alkenyl, C₂-C₂₀ alkynyl, C₆-C₂₀-aryl, C₇-C₂₀-alkylaryl or C₇-C₂₀-arylalkyl radical optionally containing one or more heteroatoms belonging to groups 13-17 of the Periodic Table of the Elements; more preferably R⁸ is a tert-butyl radical.
R¹, R², R³, R⁴ and R⁵, equal to or different from each other, are hydrogen atoms, halogen atoms or linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two adjacent R¹, R², R, R⁴ and R⁵ form one or more 3-7 membered ring optional containing heteroatoms belonging to groups 13-17 of the periodic table; such as to form with the cyclopentadienyl moiety, for example, the following radicals: indenyl; mono-, di-, tri- and tetra-methyl indenyl; 2-methyl indenyl, 3-^{t}butyl-indenyl, 2-isopropyli-4-phenyl indenyl, 2-methyl-4-phenyl indenyl, 2-methyl-4,5 benzo indenyl; 3-trimethylsilyl-indenyl; 4,5,6,7-tetrahydroindenyl; fluorenyl; 5,10-dihydroindeno[1,2-b]indol-10-yl; N-methyl- or N-phenyl-5,10-dihydroindeno [1,2-b]indol-10-yl; 5,6-dihydroindeno[2,1-b]indol-6-yl; N-methyl- or N-phenyl-5,6-dihydroindeno[2,1-b]indol-6-yl; azapentalene-4-yl; thiapentalene-4-yl; azapentalene-6-yl; thiapentalene-6-yl; mono-, di- and tri-methyl-azapentalene-4-yl, 2,5-dimethyl-cyclopenta[1,2-b:4,3-b′]-dithiophene.

Non limiting examples of compounds belonging to formula (I), (II) and (III) are the following compounds (when possible in either their meso or racemic isomers, or mixtures thereof):
bis(cyclopentadienyl)zirconium dichloride;
bis(indenyl)zirconium dichloride;
bis(tetrahydroindenyl)zirconium dichloride;
bis(fluorenyl)zirconium dichloride;
(cyclopentadienyl)(indenyl)zirconium dichloride;
(cyclopentadienyl)(fluorenyl)zirconium dichloride;
(cyclopentadienyl)(tetrahydroindenyl)zirconium dichloride;
(fluorenyl)(indenyl)zirconium dichloride;
bis(1-methyl-3-n-butyil-cyclopentadienyl)zirconium dichloride;
dimethylsilanediylbis(indenyl)zirconium dichloride,
dimethylsilanediylbis(2-methyl-4-phenylindenyl)zirconium dichloride,
dimethylsilanediylbis(4-naphthylindenyl)zirconium dichloride,
dimethylsilanediylbis(2-methylindenyl)zirconium dichloride,
dimethylsilanediylbis(2-methyl-4-t-butylindenyl)zirconium dichloride,
dimethylsilanediylbis(2-methyl-4-isopropylindenyl)zirconium dichloride,
dimethylsilanediylbis(2,4-dimethylindenyl)zirconium dichloride,
dimethylsilanediylbis(2-methyl-4,5-benzoindenyl)zirconium dichloride,
dimethylsilanediylbis(2,4,7-trimethylindenyl)zirconium dichloride,
dimethylsilanediylbis(2,4,6-trimethylindenyl)zirconium dichloride,
dimethylsilanediylbis(2,5,6-trimethylindenyl)zirconium dichloride,
methyl(phenyl)silanediylbis(2-methyl-4,6-diisopropylindenyl)-zirconium dichloride,
methyl(phenyl)silanediylbis(2-methyl-4-isopropylindenyl)-zirconium dichloride,
1,2-ethylenebis(indenyl)zirconium dichloride,
1,2-ethylenebis(4,7-dimethylindenyl)zirconium dichloride,
1,2-ethylenebis(2-methyl-4-phenylindenyl)zirconium dichloride,
1,4-butanediylbis(2-methyl-4-phenylindenyl)zirconium dichloride,
1,2-ethylenebis(2-methyl-4,6-diisopropylindenyl)zirconium dichloride,
1,4-butanediylbis(2-methyl-4-isopropylindenyl)zirconium dichloride,
1,4-butanediylbis(2-methyl-4,5-benzoindenyl)zirconium dichloride,
1,2-ethylenebis(2-methyl-4,5-benzoindenyl)zirconium dichloride,
[4-(η⁵-cyclopentadienyl)-4,6,6-trimethyl(η⁵-4,5-tetrahydro-pentalene)]dimethylzirconium,
[4-(η⁵-3′-trimethylsilylcyclopentadienyl)-4,6,6-trimethyl(η⁵-4,5-tetrahydropentalene)]dimethylzirconium,
(tert-butylamido)(tetramethyl-η⁵-cyclopentadienyl)-1,2-ethane-dimethyltitanium,
(methylamido)(tetramethyl-η⁵-cyclopentadienyl)dimethylsilyl-dimethyltitanium,
(methylamido)(tetramethyl-η⁵-cyclopentadienyl)-1,2-ethanediyl-dimethyltitanium,
(tertbutylamido)-(2,4-dichloride-2,4-pentadien-1-yl)dimethylsilyl-dimethyltitanium,
bis(1,3-dimethylcyclopentadienyl)zirconium dichloride,
methylene(3-methyl-cyclopentadienyl)-7-(2,5-dimethylcyclopentadienyl-[1,2-b:4,3-b′]dithiophene)zirconium dichloride;
methylene(3-isopropyl-cyclopentadienyl)-7-(2,5-dimethylcyclopentadienyl-[1,2-b:4,3-b′]dithiophene)zirconium dichloride;
methylene(2,4-dichloride-cyclopentadienyl)-7-(2,5-dimethylcyclopentadienyl-[1,2-b:4,3-b′]dithiophene)zirconium dichloride;
methylene(2,3,5-trimethyl-cyclopentadienyl)-7-(2,5-dimethylcyclopentadienyl-[1,2-b:4,3-b′]dithiophene)zirconium dichloride;
methylene-1-(indenyl)-7-(2,5-dimethylcyclopentadienyl-[1,2-b:4,3-b′]dithiophene)zirconium dichloride and dichloride;
methylene-1-(indenyl)-7-(2,5-ditrimethylsilylcyclopentadienyl-[1,2-b:4,3-b′]dithiophene)zirconium dichloride;
methylene-1-(3-isopropyl-indenyl)-7-(2,5-dimethylcyclopentadienyl-[1,2-b:4,3-b′]dithiophene)zirconium dichloride;
methylene-1-(2-methyl-indenyl)-7-(2,5-dimethylcyclopentadienyl-[1,2-b:4,3-b′]dithiophene)zirconium dichloride;
methylene-1-(tetrahydroindenyl)-7-(2,5-dimethylcyclopentadienyl-[1,2-b:4,3-b′]dithiophene)zirconium dichloride;
methylene(2,4-dichloride-cyclopentadienyl)-7-(2,5-dimethylcyclopentadienyl-[1,2-b:4,3-b′]dioxazol)zirconium dichloride;
methylene(2,3,5-trimethyl-cyclopentadienyl)-7-(2,5-dimethylcyclopentadienyl-[1,2-b:4,3-b′]dioxazol)zirconium dichloride;
methylene-1-(indenyl)-7-(2,5-dimethylcyclopentadienyl-[1,2-b:4,3-b′]dioxazol)zirconium dichloride and dichloride;
isopropylidene(3-methyl-cyclopentadienyl)-7-(2,5-dimethylcyclopentadienyl-[1,2-b:4,3-b′]dithiophene)zirconium dichloride;
isopropylidene(2,4-dichloride-cyclopentadienyl)-7-(2,5-dimethylcyclopentadienyl-[1,2-b:4,3-b′]dithiophene)zirconium dichloride;
isopropylidene(2,4-diethyl-cyclopentadienyl)-7-(2,5-dimethylcyclopentadienyl-[1,2-b:4,3-b′]dithiophene)zirconium dichloride;
isopropylidene(2,3,5-trimethyl-cyclopentadienyl)-7-(2,5-dimethylcyclopentadienyl-[1,2-b:4,3-b′]dithiophene)zirconium dichloride;
isopropylidene-1-(indenyl)-7-(2,5-dimethylcyclopentadienyl-[1,2-b:4,3-b′]dithiophene)zirconium dichloride;
isopropylidene-1-(2-methyl-indenyl)-7-(2,5-dimethylcyclopentadienyl-[1,2-b:4,3-b′]dithiophene)zirconium dichloride;
dimethylsilandiyl-1-(2-methyl-indenyl)-7-(2,5-dimethylcyclopentadienyl-[1,2-b:4,3-b′]dithiophene)hafnium dichloride;
dimethylsilanediyl(3-tert-butyl-cyclopentadienyl)(9-fluorenyl)zirconium dichloride,
dimethylsilanediyl(3-isopropyl-cyclopentadienyl)(9-fluorenyl)zirconium dichloride,
dimethylsilanediyl(3-methyl-cyclopentadienyl)(9-fluorenyl)zirconium dichloride,
dimethylsilanediyl(3-ethyl-cyclopentadienyl)(9-fluorenyl)zirconium dichloride,
1-2-ethane(3-tert-butyl-cyclopentadienyl)(9-fluorenyl)zirconium dichloride,
1-2-ethane (3-isopropyl-cyclopentadienyl)(9-fluorenyl)zirconium dichloride,
1-2-ethane (3-methyl-cyclopentadienyl)(9-fluorenyl)zirconium dichloride,
1-2-ethane (3-ethyl-cyclopentadienyl)(9-fluorenyl)zirconium dichloride,
dimethylsilandiylbis-6-(3-methylcyclopentadienyl-[1,2-b]-thiophene)dichloride;
dimethylsilandiylbis-6-(4-methylcyclopentadienyl-[1,2-b]-thiophene)zirconium dichloride;
dimethylsilandiylbis-6-(4-isopropylcyclopentadienyl-[1,2-b]-thiophene)zirconium dichloride;
dimethylsilandiylbis-6-(4-ter-butylcyclopentadienyl-[1,2-b]-thiophene)zirconium dichloride;
dimethylsilandiylbis-6-(3-isopropylcyclopentadienyl-[1,2-b]-thiophene)zirconium dichloride;
dimethylsilandiylbis-6-(3-phenylcyclopentadienyl-[1,2-b]-thiophene)zirconium dichloride;
dimethylsilandiylbis-6-(2,5-dichloride-3-phenylcyclopentadienyl-[1,2-b]-thiophene)zirconium di methyl;
dimethylsilandiylbis-6-[2,5-dichloride-3-(2-methylphenyl)cyclopentadienyl-[1,2-b]-thiophene]zirconium dichloride;
dimethylsilandiylbis-6-[2,5-dichloride-3-(2,4,6-trimethylphenyl)cyclopentadienyl-[1,2-b]-thiophene]zirconium dichloride;
dimethylsilandiylbis-6-[2,5-dichloride-3-mesitylenecyclopentadienyl-[1,2-b]-thiophene]zirconium dichloride;
dimethylsilandiylbis-6-(2,4,5-trimethyl-3-phenylcyclopentadienyl-[1,2-b]-thiophene)zirconium dichloride;
dimethylsilandiylbis-6-(2,5-diethyl-3-phenylcyclopentadienyl-[1,2-b]-thiophene)zirconium dichloride;
dimethylsilandiylbis-6-(2,5-diisopropyl-3-phenylcyclopentadienyl-[1,2-b]-thiophene)zirconium dichloride;
dimethylsilandiylbis-6-(2,5-diter-butyl-3-phenylcyclopentadienyl-[1,2-b]-thiophene)zirconium dichloride;
dimethylsilandiylbis-6-(2,5-ditrimethylsilyl-3-phenylcyclopentadienyl-[1,2-b]-thiophene)zirconium dichloride;
dimethylsilandiylbis-6-(3-methylcyclopentadienyl-[1,2-b]-silole)zirconium dichloride;
dimethylsilandiylbis-6-(3-isopropylcyclopentadienyl-[1,2-b]-silole)zirconium dichloride;
dimethylsilandiylbis-6-(3-phenylcyclopentadienyl-[1,2-b]-silole)zirconium dichloride;
dimethylsilandiylbis-6-(2,5-dichloride-3-phenylcyclopentadienyl-[1,2-b]-silole)zirconium dichloride;
dimethylsilandiylbis-6-[2,5-dichloride-3-(2-methylphenyl)cyclopentadienyl-[1,2-b]-silole]zirconium dichloride;
dimethylsilandiylbis-6-[2,5-dichloride-3-(2,4,6-trimethylphenyl)cyclopentadienyl-[1,2-b]-silole]zirconium dichloride;
dimethylsilandiylbis-6-[2,5-dichloride-3-mesitylenecyclopentadienyl-[1,2-b]-silole]zirconium dichloride;
dimethylsilandiylbis-6-(2,4,5-trimethyl-3-phenylcyclopentadienyl-[1,2-b]-silole)zirconium dichloride;
[dimethylsilyl(tert-butylamido)][tetramethylpentadienyl]titanium dichloride;
[dimethylsilyl(tert-butylamido)][1-indenyl]titanium dichloride;
[dimethylsilyl(tert-butylamido)][9-fluorenyl]titanium dichloride;
[dimethylsilyl(tert-butylamido)][(N-methyl-1,2-dihydrocyclopenta[2,1-b]indol-2-yl)]titanium dichloride;
[dimethylsilyl(tert-butylamido)][(6-methyl-N-methyl-1,2-dihydrocyclopenta[2,1-b]indol-2-yl)]titanium dichloride;
[dimethylsilyl(tert-butylamido)][(6-methoxy-N-methyl-1,2-dihydrocyclopenta[2,1-b]indol-2-yl)]titanium dichloride;
[dimethylsilyl(tert-butylamido)][(N-ethyl-1,2-dihydrocyclopenta[2,1-b]indol-2-yl)]titanium dichloride;
[dimethylsilyl(tert-butylamido)][(N-phenyl-1,2-dihydrocyclopenta[2,1-b]indol2-yl)]titanium dichloride;
[dimethylsilyl(tert-butylamido)][(6-methyl-N-phenyl-1,2-dihydrocyclopenta[2,1-b]indol2-yl)]titanium dichloride;
[dimethylsilyl(tert-butylamido)][(6-methoxy-N-phenyl-1,2-dihydrocyclopenta[2,1-b]indol2-yl)]titanium dichloride;
[dimethylsilyl(tert-butylamido)][(N-methyl-3,4-dichloride-1,2-dihydrocyclopenta[2,1-b]indol-2-yl)]titanium dichloride;
[dimethylsilyl(tert-butylamido)][(N-ethyl-3,4-dichloride-1,2-dihydrocyclopenta[2,1-b]indol-2-yl)]titanium dichloride;
[dimethylsilyl(tert-butylamido)][(N-phenyl-3,4-dichloride-1,2-dihydroclopenta[2,1-b]indol-2-yl)]titanium dichloride; dimethylsilandiylbis(2-methyl-4-p-tert-butylphenylindenyl)zirconium dichloride;
dimethylsilandiyl(2-isopropyl-4-p-tert-butylphenylindenyl)(2-methyl-4-p-tert-butylphenylindenyl)zirconium dichloride;
dimethylsilandiyl(2-isopropyl-4-p-tert-butylphenylindenyl)(2-methyl-4-p-tert-butyl-7-methylphenylindenyl)zirconium dichloride;
   as well as the corresponding zirconium dimethyl, hydrochloro dihydro and η⁴⁻butadiene compounds.

Suitable metallocene complexes belonging to formulas (I), (II) or (III) are described in WO 98/22486, WO 99/58539 WO 99/24446, U.S. Pat. No. 5,556,928, WO 96/22995, EP485822, EP-485820, U.S. Pat. No. 5,324,800, EP-A-0 129 368, U.S. Pat. No. 5,145,819, EP-A-0 485 823, WO 01/47939, WO 01/44318, PCT/EP02/13552, EP-A-0 416 815, EP-A-0 420 436, EP-A-0 671 404, EP-A-0 643 066 and WO-A-91/04257.

Alumoxanes used as component (b) can be obtained by reacting water with an organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number. In this reaction the molar ratio of Al/water is preferably comprised between 1:1 and 100:1.

The molar ratio between aluminium and the metal of the metallocene is generally comprised between about 10:1 and about 30000:1, preferably between about 100:1 and about 5000:1.

The alumoxanes used in the catalyst according to the invention are considered to be linear, branched or cyclic compounds containing at least one group of the type:

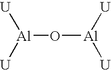

wherein the substituents U, same or different, are defined above.

In particular, alumoxanes of the formula:

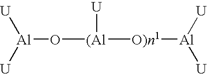

can be used in the case of linear compounds, wherein n¹ is 0 or an integer of from 1 to 40 and the substituents U are defined as above; or alumoxanes of the formula:

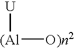

can be used in the case of cyclic compounds, wherein n2 is an integer from 2 to 40 and the U substituents are defined as above.

Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO).

Particularly interesting cocatalysts are those described in WO 99/21899 and in WO01/21674 in which the alkyl and aryl groups have specific branched patterns.

Non-limiting examples of aluminium compounds that can be reacted with water to give suitable alumoxanes (b), described in WO 99/21899 and WO01/21674, are: tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-butyl)aluminium, tris(2,3-dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminium (TMA), triisobutylaluminium (TIBA), tris(2,4,4-trimethyl-pentyl)aluminium (TIOA), tris(2,3-dimethylbutyl)aluminium (TDMBA) and tris(2,3,3-trimethylbutyl)aluminium (TTMBA) are preferred. Particularly interesting cocatalysts are also those described in WO 00/24787.

Non-limiting examples of compounds able to form an alkylmetallocene cation are compounds of formula D⁺E⁻, wherein D⁺ is a Brø-nsted acid, able to donate a proton and to react irreversibly with a substituent X of the metallocene of formula (I) and E⁻ is a compatible anion, which is able to stabilize the active catalytic species originating from the reaction of the two compounds, and which is sufficiently labile to be removed by an olefinic monomer. Preferably, the anion E⁻ comprises one or more boron atoms. More preferably, the anion E⁻ is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentafluorophenyl borate is particularly preferred compound, as described in WO 91/02012. Moreover, compounds of formula BAr₃ can be conveniently used. Compounds of this type are described, for example, in the International patent application WO 92/00333. Other examples of compounds able to form an alkylmetallocene cation are compounds of formula BAr₃P wherein P is a substituted or unsubstituted pyrrol radical. These compounds are described in WO01/62764. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.
Non limiting examples of compounds of formula D⁺E⁻ are:
Triethylammoniumtetra(phenyl)borate,
Tributylammoniumtetra(phenyl)borate,
Trimethylammoniumtetra(tolyl)borate,
Tributylammoniumtetra(tolyl)borate,
Tributylammoniumtetra(pentafluorophenyl)borate,
Tributylammoniumtetra(pentafluorophenyl)aluminate,
Tripropylammoniumtetra(dimethylphenyl)borate,
Tributylammoniumtetra(trifluoromethylphenyl)borate, Tributylammoniumtetra(4-fluorophenyl)borate,
N,N-Dimethylbenzylammoniumtetrakis(pentafluorophenyl)borate,
N,N-Dimethylcyclohexylamoniumtetrakis(pentafluorophenyl)borate,
N,N-Dimethylaniliniumtetra(phenyl)borate,
N,N-Diethylaniliniumtetra(phenyl)borate,
N,N-Dimethylaniliniumtetrakis(pentafluorophenyl)borate,
N,N-Dimethylaniliniumtetrakis(pentafluorophenyl)aluminate,
N,N-Dimethylbenzylammonium-tetrakispentafluorophenyl aluminate,
N,N-Dimethylcyclohexylamonium-tetrakispentafluorophenyl aluminate,
Di(propyl)ammoniumtetrakis(pentafluorophenyl)borate,
Di(cyclohexyl)ammoniumtetrakis(pentafluorophenyl)borate,
Triphenylphosphoniumtetrakis(phenyl)borate,
Triethylphosphoniumtetrakis(phenyl)borate,
Diphenylphosphoniumtetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(pentafluorophenyl)aluminate,
Triphenylcarbeniumtetrakis(phenyl)aluminate,
Ferroceniumtetrakis(pentafluorophenyl)borate,
Ferroceniumtetrakis(pentafluorophenyl)aluminate and
Triphenylcarbeniumtetrakis(pentafluorophenyl)borate.

Organic aluminum compounds used as compound c) are those of formula HⱼAlU₃₋ⱼ or HⱼAl₂U₆₋ⱼ as described above.

Besides in prepolymerization, a molecular weight regulator, such as hydrogen, can also be used in the polymerization reactor.

Propylene polymer resin (A) obtainable with metallocene catalysts may be prepared, either batchwise or preferably continuously, in the reactors which are usual for polymerizing olefins. Examples of suitable reactors are continuously-operated stirred tank reactors, and it is also possible, if desired, to use a series of more than one stirred tank reactor connected in series. The polymerization reactions may be carried out in the gas phase, in suspension, in liquid monomers, in supercritical monomers, or in inert solvents.

The polymerization conditions are not critical per se. The polymerizations of propylene, optionally with an α-olefin, is preferably carried out in the gas phase, for example in fluidized-bed reactors or in agitated powder bed reactors. Polymerization conditions well suited for this are polymerization pressures in the range from 10 to 40 bar and polymerization temperatures in the range from 50 to 100° C. The polymerization may also, of course, take place in a series of more than one, preferably two, reactors connected to one another in series.

The average molar mass of the polymers may be controlled using the methods usual in polymerization technology, for example by introducing molar mass regulators, such as hydrogen, which gives a reduction in the molar mass of the polymer, or by varying the polymerization temperature. High polymerization temperatures likewise usually give reduced molar masses.

The polyolefin composition according to the present invention is prepared as follows. Propylene polymer (B) can be blended to polymer resin (A) in neat form or, preferably, as part of a masterbatch, in such a case propylene polymer (B) is previously dispersed in a propylene polymer resin that can be same as or different from polymer resin (A). The concentrate thus prepared is then blended to polymer resin (A).

The polyolefin composition according to the present invention can also comprise further polymers in addition to polymer (A), in particular polyolefins. For example, crystalline or semi-crystalline isotactic propylene polymers having a molecular weight distribution ( M̅_{w}/ M̅ₙ) measured by GPC, higher than 3, such as those produced by Ziegler-Natta catalysts. In the polyolefin composition the mixing ratios of polymer (A) and further polymer is indicatively from 1:0.25 to 1:0.1. However, any mixing ratio of the polymers

The propylene polymer composition according to the present invention can be prepared according to conventional methods, for examples, mixing polymer resin (A), polymer (B) or the concentrate thereof and well known additives in a blender, such as a Henschel or Banbury mixer, to uniformly disperse the said components, at a temperature equal to or higher than the polymer softening temperature, then extruding the composition and pelletizing.

The polymer composition is usually added with additives and/or peroxides, whenever the latter are necessary to obtain the desired MFR.

The said additives added to the above mentioned polymers or polymer composition comprise the common additives to polymers such as pigments, opacifiers, fillers, stabilizers, flame retardants, antacids and whiteners.

Another embodiment of the present invention is a process for the preparation of said fibre in which the invented polyolefin composition is spun.

Yet another embodiment of the present invention relates to articles, in particular non-woven fabrics, produced with the above-mentioned fibres.

Both fibres and articles produced with the fibres are produces according to known methods. In particular, the fabric of the present invention can be prepared with the well-known processes for the preparation of spun-bond non-woven fabrics, with which the fibres are spread to form directly a fibre web and calendered so as to obtain the non-woven fabric.

In a typical spunbonding process, the polymer is heated in an extruder to the melting point of the polyolefin composition and then the molten polyolefin composition is pumped under pressure through a spinneret containing a number of orifices of desired diameter, thereby producing filaments of the molten polymer composition and without subjecting the filaments to a subsequent drawing.

The equipment is characterised by the fact that it includes an extruder with a die on its spinning head, a cooling tower an air suction gathering device that uses Venturi tubes.

Underneath this device that uses air speed to control the filaments speed and are usually gathered over a conveyor belt, where they are distributed forming a web according to the well-known method.

When using typical spunbonding machinery, it is usually convenient to apply the following process conditions:
the output per hole ranges from 0.1 to 2 g/min, preferably from 0.2 to 1.5 g/min;
the molten polymer filaments fed from the face of the spinneret are generally cooled by means of an air flow and are solidified as a result of cooling;
the spinning temperature is generally between 200° and 300° C.

The fabric can be constituted by monolayer or multilayer non-woven fabrics.

In a preferred embodiment, the non-woven fabric is multilayered and at least one layer comprises fibres formed from said polyolefin composition. The other layer may be obtained by spinning processes other than spunbonding and may comprise other types of polymers.

The particulars are given in the following examples, which are given to illustrate, without limiting, the present invention.

The following analytical methods have been used to determine the properties reported in the detailed description and in the examples.
Melt flow rate: Determined according to ISO method 1133 (230° C. and 2.16 kg).
Molecular weight ( M̅ₙ, M̅_{w}): Measured by way of gel permeation chromatography (GPC) in 1,2,4-trichlorobenzene.
Melt strength: Measured with a Rheotens Melt Tension Instrument model 2001, by Gottfert (Germany). The method consists of measuring the resistance, expressed in cent/Newton (cN), presented by the traction of a molten polymer strand, operating at a set drawing velocity. In particular, the polymer to be tested is extruded at 200° C., through a die with a capillary hole 22 mm long and 1 mm in diameter. The molten exiting strand is then drawn by a system of pulleys at a constant acceleration of 0.012 cm/sec², while measuring the tension of the strand until complete break occurs. The apparatus registers tension values (resistance in cN) of the strand as a function of the extant of the draw. The maximum tension is reached when the strand breaks and this corresponds to the melt strength.
Melting temperature and Temperature of crystallization: Determined according to ISO 11357-3.
Peak time: Determined according to ISO 11357-7.
Tenacity and Elongation at break of filaments: A 100 mm long segment is cut from a 500 m roving. From this segment the single fibres to be tested are randomly chosen. Each single fibre to be tested is fixed to the clamps of an Instron dinamometer (model 1122) and tensioned to break with a traction speed of 20 mm/min for elongations lower than 100% and 50 mm/min for elongations greater than 100%, the initial distance between the clamps being of 20 mm. The ultimate strength (load at break) and the elongation at break are determined.

The tenacity is derived using the following equation:

Tenacity=Ultimate strength(cN)×110/Titre(dtex).

### Components Used in the Examples and Comparative Examples

The following isotactic propylene homopolymers are used.

| | MFR | | Solubility in |
|---|---|---|---|
| Polymer | g/10 min | M̅w/ M̅n | xylene wt % |
| Polymer A1 | 30 | 1.8 | 0.8 |
| Polymer A2 | 15 | 1.7 | 0.8 |
| Polymer A3 | 15 | 1.95 | 0.4 |
| Polymer A4 | 30 | 3 | 3 |

Polymers A1 to A3 are commercial polymers prepared directly with the reported MFR values by homopolymerising propylene in the presence of a catalyst system consisting of the racemic form of the dimethylsilylenebis(2-methyl-4,5-benzoindenyl)zirconium dichloride, which is prepared according to U.S. Pat. No. 5,932,669, as catalyst and methylalumoxane as cocatalyst. The polymerisation is carried out in liquid phase.
Polymer A4 is a commercial isotactic propylene polymer prepared by polymerising propylene in the presence of a Ziegler-Natta catalyst. The polymer obtained by reactor has an MFR value of 1.5 g/10 min and then is subjected to chemical degradation up to an MFR value of 30 g/10 min by means of peroxides.
Isotactic propylene homopolymer with high melt strength (polymer B) marketed by Basell with the trademark Profax PF814. The polymer has a branch index of 0.6, melt strength of 26.7 cN and MFR value of 2.7 g/10 min.
Masterbatch 1 is a mechanical blend consisting of 98.27% by weight of a crystalline isotactic propylene homopolymer having an MFR value of 20 g/10 min, 1.6 wt % of polymer B, 0.03 wt % of calcium stearate and 0.1 wt % of bis(2,4-di-tert-butylphenyl)phosphite marketed by Ciba-Geigy with the trademark Irgafos 168.

### EXAMPLE 1 AND COMPARATIVE EXAMPLE 1

It is prepared a polymer composition by mixing and extruding the polymer components listed in Table 1 and the below-mentioned additives in a Leistriz 27 extruder under the following conditions:
temperature of the melt polymer composition: 195° C.;
pressure: 57 bar;
rotational speed of the screw: 200 rpm;
discharge: 12 kg/hour.

The composition contains 0.03 wt % of calcium stearate and 0.08 wt % of Irgafos 168.

The polymer components and properties of the composition thus obtained are reported in Table 1.

The composition is then subjected to spinning by operating at the conditions set forth below:
spinning temperature: 250° C.;
hole diameter: 0.6 mm;
hole output: 1 g/min.

The spun fibres are gathered and tested. In Table 2 the properties of the fibres are reported.

### COMPARATIVE EXAMPLES 2 AND 3

Example 1 is repeated except that the spinning temperature is increased to 280° C. and the hole output is 0.6 g/min. The polymer components and their amounts are reported in Table 1.

In Table 1 the properties of the composition and fibres are reported.

TABLE 1

| | | | | Comparative | |
|---|---|---|---|---|---|
| | | Comparative | | Examples | |
| Components and Properties | | Example 1 | Example 1 | 2 | 3 |
| Polymer A, parts | A1 | 100 | 100 | 0 | 0 |
| by weight | A2 | 0 | 0 | 100 | 100 |

| | | | | |
|---|---|---|---|---|
| MFR of polymer A, g/10 min | 30 | 30 | 15 | 15 |
| Polymer B, parts by weight | 0 | 0.16 | 0 | 0.16 |
| Melting temperature, ° C. | 145.5 | 145.1 | 146.9 | 146.3 |
| Temperature of crystallization, ° C. | 106.7 | 107.3 | 109.3 | 109.7 |
| Peak time at 125° C., min | 12.2 | 9.33 | 5.267 | 5.53 |

Spinning Condition and Properties of the Composition

| | | | | |
|---|---|---|---|---|
| Maximum spinning speed, m/min | 4500 | 4500 | 4200 | 3900 |
| Tenacity, cN/dtex | 32 | 28.9 | 35.6 | 31.3 |
| Decrease of tenacity with respect to | — | −10 | — | −12 |
| polymer A alone, % | | | | |
| Elongation at break, % | 125 | 235 | 170 | 175 |
| Increase of elongation at break with | — | +88 | — | +3 |
| respect to polymer A alone, % | | | | |

### EXAMPLE 2 AND COMPARATIVE EXAMPLE 4

Example 1 is repeated except that polymer B is added in form of masterbatch 1. Polymer (A) and masterbatch are in the ratio of 4 to 1. The polymer components and their amounts are reported in Table 2.

### COMPARATIVE EXAMPLES 5 AND COMPARATIVE EXAMPLE 6

Example 2 is repeated except that the spinning temperature is increased to 280° C. The polymer components and their amounts are reported in Table 2.

In Table 2 the properties of the composition and fibres are reported.

TABLE 2

| | | Comparative | | Comparative Examples | |
|---|---|---|---|---|---|
| Components and Properties | | Example 4 | Example 2 | 5 | 6 |
| Polymer A, parts | A1 | 100 | 100 | 0 | 0 |
| by weight | A3 | 0 | 0 | 100 | 100 |

| | | | | |
|---|---|---|---|---|
| MFR of polymer A, g/10 min | 30 | 30 | 15 | 15 |
| Polymer B, parts by weight | 0 | 0.40¹⁾ | 0 | 0.40¹⁾ |
| Melting temperature, ° C. | 148.3 | 152.1 | 147.5 | 152.2 |
| Temperature of crystallization, ° C. | 111.1 | 112.5 | 110.7 | 111.5 |
| Peak time at 125° C., min | 12.2 | 9.33 | 5.267 | 5.53 |

Spinning Condition and Properties of the Composition

| | | | | |
|---|---|---|---|---|
| Maximum spinning speed, m/min | 4500 | 4200 | 4800 | 3900 |
| Tenacity, cN/dtex | 35.3 | 30.7 | 33.7 | 24.2 |
| Decrease of tenacity with respect to | — | −13 | — | −28 |
| polymer A alone, % | | | | |
| Elongation at break, % | 170 | 370 | 185 | 250 |
| Increase of elongation at break with | — | +118 | — | +35 |
| respect to polymer A alone, % | | | | |

¹⁾Parts of polymer (B) with respect to the whole polymer mixture of polymer (A) and masterbatch 1.

### COMPARATIVE EXAMPLES 7 AND 8

Example 1 repeated. The polymer components and their amounts are recorded in Table 3.

TABLE 3

| | Comparative | Comparative |
|---|---|---|
| Components and Properties | Example 7 | Example 8 |
| Polymer A4, parts by weight | 100 | 100 |
| Polymer B, parts by weight | 0 | 0.32 |
| Melting temperature, ° C. | 162.1 | 163.4 |
| Peak time at 125° C., min | 5 | 0.667 |

Spinning Condition and Properties of the Composition

| | | |
|---|---|---|
| Maximum spinning speed, m/min | 4800-5100 | 2700 |
| Tenacity, cN/dtex | 25 | 25.8 |
| Decrease of tenacity with respect to | — | +3.2 |
| polymer A4 alone, % | | |
| Elongation at break, % | 250 | 345 |
| Increase of elongation at break with | — | +38 |
| respect to polymer A5 A4 alone, % | | |

The results reported in the above tables show that the fibres according to the present invention exhibit a better balance of properties between tenacity and elongation at break. The improved elongation at break obtained by the fibres of the invention compared to the fibres having different composition is achieved without remarkably sacrificing tenacity.

In addition, the said better balance of properties can even be achieved at the same maximum spinning speed of fibre production as the high-melt-strength polymer-free fibres.

In particular, the results of the comparative fibres recorded in Table 3 show that even though the prior art fibre exhibits higher tenacity and elongation at break, the said improvement is slight and the spinnability of composition is remarkably worsened.

1. A polyolefin composition comprising (parts by weight):
A) 100 parts of a crystalline isotactic propylene polymer resin (A) comprising:
1) a molecular weight distribution expressed by a first ratio of the weight average molecular weight to numeric average molecular weight, M̅_{w}/ M̅ₙ, measured by GPC, of less than 3:
2) a proportion of inversely inserted propylene units based on 2,1 insertions of a propylene monomer in all propylene insertions as low as 0.5% or less; and
3) melt flow rate (MFR) from 20 to 60 g/10 min; and
B) 0.1-1 part of a high molecular weight propylene polymer (B) having a melt strength from 5 to 40 cN.

2. The polyolefin composition of claim 1 wherein polymer B) is 0.15-0.6 part by weight.

3. The polyolefin composition of claim 2 wherein polymer B) is over 0.2 to 0.6 part by weight.

4. The polyolefin composition of claim 1 wherein the polyolefin composition further comprises a crystalline or semi-crystalline isotactic propylene polymer having a molecular weight distribution expressed by a second ratio of the weight average molecular weight to numeric average molecular weight, M̅_{w}/ M̅ₙ, measured by GPC, higher than 3.

5. A fibre comprising a polyolefin composition comprising:
A) 100 parts of a crystalline isotactic propylene polymer resin (A) comprising:
1) a molecular weight distribution expressed by a first ratio of the weight average molecular weight to numeric average molecular weight, M̅_{w}/ M̅ₙ, measured by GPC of less than 3;
2) a proportion of inversely inserted propylene units based on 2,1 insertions of a propylene monomer in all propylene insertions as low as 0.5% or less, and
3) a melt flow rate (MFR) from 20 to 60 g/10 min; and
B) 0.1-1 part of a high molecular weight propylene polymer (B) having a melt strength from 5 to 40 cN.

6. A process for the production of polyolefin fibres comprising spinning a polyolefin composition comprising:
A) 100 parts of a crystalline isotactic propylene polymer resin (A) comprising:
1) a molecular weight distribution expressed by a first ratio of the weight average molecular weight to numeric average molecular weight, M̅_{w}/ M̅ₙ, measured by GPC, of less than 3;
2) a proportion of inversely inserted propylene units based on 2,1 insertions of a propylene monomer in all propylene insertions as low as 0.5% or less, and
3) a melt flow rate (MFR) from 20 to 60 g/10 min; and
B) 0.1-1 part of a high molecular weight propylene polymer (B) having a value of melt strength from 5 to 40 cN.

7. A process comprising spinning a polyolefin composition comprising:
A) 100 parts of a crystalline isotactic propylene polymer resin (A) comprising:
1) a molecular weight distribution expressed by a first ratio of the weight average molecular weight to numeric average molecular weight, M̅_{w}/ M̅ₙ, measured by GPC, of less than 3;
2) a proportion of inversely inserted propylene units based on 2,1 insertions of a propylene monomer in all propylene insertions as low as 0.5% or less; and
3) a melt flow rate (MFR) from 20 to 60 g/10 min; and
B) 0.1-1 part of a high molecular weight propylene polymer (B) having a melt strength from 5 to 40 cN,
thereby forming fibres; and
bonding the fibres to form a non-woven fabric.

8. Non-woven fabrics comprising fibres comprising:
a polyolefin composition comprising (parts by weight):
A) 100 parts of a crystalline isotactic propylene polymer resin (A) comprising:
1) a molecular weight distribution expressed by a first ratio of the weight average molecular weight to numeric average molecular weight, M̅_{w}/ M̅ₙ, measured by GPC, of less than 3;
2) a proportion of inversely inserted propylene units based on 2,1 insertions of a propylene monomer in all propylene insertions as low as 0.5% or less; and
3) a melt flow rate (MFR) from 20 to 60 g/10 min; and
B) 0.1-1 part of a high molecular weight propylene polymer (B) having a melt strength from 5 to 40 cN.
